(19) United States
(12) Patent Application Publication
(10) Pub. No.: US 2010/0297306 A1
(43) Pub. Date: Nov. 25, 2010

(54) LOW TRANS FATTY ACID COMPOSITIONS FOR USE IN MICROWAVE POPCORN COMPOSITIONS; METHODS; AND, PRODUCTS

(75) Inventors: Jody Shands, Plymouth, MN (US); Jamie Sloneker Halgerson, Shakopee, MN (US); Turiddu A. Pelloso, Carmel, IN (US); Tim Puhek, Andover, MN (US); Lance Schilmoeller, Minnetonka, MN (US)

Correspondence Address: Merchant & Gould - ConAgra, P.O. Box 2903, Minneapolis, MN, 55402, US

(73) Assignee: CONAGRA FOODS , INC., Edina, MN (US)

(21) Appl. No.: 11/917,377

(22) PCT Filed: Jun. 28, 2005
(86) PCT No.: PCT/US2005/023233

§ 371 Date: Jul. 8, 2010

Related U.S. Application Data
(60) Provisional application No. 60/583,762, filed on Jun. 29, 2004.
(60) Provisional application No. 60/586,329, filed on Jul. 8, 2004.

(51) Int. Cl. A23L 1/18; B65D 81/34

(52) U.S. Cl. 426/107

(57) ABSTRACT

A preferred oil/fat material for use in packaged microwaveable popcorn products is provided. The oil/fat material has a Mettler drop point of at least 90° F. (32.2° C.) and no greater than 145° F. (62.8° C.). It includes a first oil/fat component comprising at least 90% by weight of an oil/fat material as described. Typical compositions and package arrangements are shown and described.

This application is being filed as a PCT International Patent application on 28 Jun. 2005, in the name of Con Agra Foods Inc., a U.S. national corporation, applicant for the designation of all countries except the U.S. and Jody Shands, Jamie Sloneker Halgerson, Turiddu A. Pelloso, Tim Puhek and Lance Schilmoeller, all U.S. citizens, applicants for the designation of the U.S. only, and claims priority to U.S. Application Ser. Nos. 60/583,762 filed 29 Jun. 2004 and 60/586,329 filed 8 Jul. 2004.

### FIELD OF THE INVENTION

The present disclosure relates to microwave popcorn products. In particular, the disclosure concerns consumer products in which a microwave popcorn composition is contained within a package construction along with unpopped kernels of microwaveable popcorn. The disclosure concerns provision in the composition of an oil/fat component, which is, preferably, relatively low in any trans fatty acid component.

### BACKGROUND

Microwave popcorn popping packages, such as flexible bags or tubs, are common. A common feature of the bags is that they are often made from paper materials that are sufficiently flexible to open or expand conveniently under steam pressure, which forms when a popcorn charge therein is exposed to microwave energy in a microwave oven. Also, the packaging materials of the bags are sufficiently flexible to be formed from a sheet into a folded configuration, for example during a continuous bag construction process. Popcorn bags of this type are described, for example, in U.S. Pat. Nos. 5,044,777; 5,081,330; 5,195,829; 6,049,072; and, 6,396,036, each of these five references being incorporated by reference herein.

Tub compositions are typically more rigid, being made from a paper board or similar material. Microwave popcorn tubs are described for example in U.S. Pat. Nos. 5,008,024; 5,097,107; and 5,834,046. The complete disclosures of these three microwave tub patents are being incorporated herein by reference.

Many microwave popcorn products include a charge of unpopped popcorn kernels, fat/oil and flavoring (for example salt) within the package. During storage or shipment, especially if the environment becomes relatively hot, certain of the materials stored within the packages can leak or wick at undesirable levels through the package construction. To inhibit such leakage, solid fat/oil products having melting point or softening temperatures (for example Mettler drop points) typically within the range of 90°-115° F. (32° to 46° C.) or more, for example about 104° F. (40° C.) are used.

In general, there has been a consumer nutritional movement to favor compositions made with relatively low or no levels of trans fatty acids therein. With respect to microwave popcorn compositions, this has led to some significant issues since low trans fatty acid fat/oils are ones which typically have a relatively low melting point or softening point. Indeed many, for example non-hydrogenated soy bean oil, are liquid at room temperature. Thus, they have had a tendency to show undesirable levels of leak or wick from microwave popcorn packages, during storage, handling or use.

In U.S. patent application Ser. No. 10/299,537 filed Nov. 18, 2002 (published in the U.S. as 2004/0096550 A1 on May 20, 2004 and published as PCT WO 2004/045308 on Jun. 3, 2004, the three referenced documents being incorporated herein by reference), an approach to addressing this problem was provided by using a low trans fatty acid in a liquefied form stored inside of an internal pouch positioned inside of a microwave popcorn bag. Improvements and alternates for microwave popcorn compositions and products are desired.

### SUMMARY OF THE DISCLOSURE

The present disclosure concerns microwave popcorn compositions and products. Arrangements and techniques are disclosed, which concern the utilization of an oil/fat component within the compositions, according to a preferred composition. Example packaged products are described.

### BRIEF DESCRIPTION OF THE DRAWINGS

FIG. 1 is a perspective view of a package arrangement including an oil/fat component of the present disclosure therein; the package of FIG. 1 being included in a storage overwrap.

FIG. 2 is a plan view of the package of FIG. 1, shown removed from the storage overwrap and unfolded for popping of microwave popcorn therein, in a microwave oven.

FIG. 3 is a top plan view of a package blank useable to form the arrangement of FIG. 2.

FIG. 4 is a cross-sectional view taken along line 4-4, FIG. 2.

FIG. 5 is a view analogous to FIG. 3, but with symbols indicating dimensions found in this text.

FIG. 6 is a cross-sectional view of a tub including an oil/fat component according to the present disclosure.

FIG. 7 is a top plan view of an alternate sheet of flexible material from which bag such as that shown in FIGS. 1 and 2 can be folded; the arrangement of FIG. 7 including markings to indicate where adhesive is preferably positioned in the construction.

FIG. 8 is a view analogous to FIG. 7, with letters indicating example dimensions found in this text.

FIG. 9 is a top plan view of an example adhesive pattern used between two sheets of flexible material, to provide a two-ply bag.

FIG. 10 is a large top plan view of an adhesive pattern of FIG. 9.

In some of the drawings, in some instances, relative component thicknesses may be shown exaggerated.

### DETAILED DESCRIPTION

### I. General Description

According to the present disclosure a packaged microwaveable popcorn product is provided. In general the product includes a closed microwave popcorn package, for example a tub or bag. Inside the package is placed unpopped popcorn kernels and a slurry. The term “slurry” as used herein, unless otherwise stated, is meant to describe all food (edible) components included within the package, not counting the unpopped popcorn kernels themselves. A typical component in a microwave popcorn slurry, is an oil/fat material. The oil/fat material generally and preferably has a melting point (Mettler drop point) of at least 90° F. (32° C.), and preferably no greater than 145° F. (62.8° C.). Typically and preferably the Mettler drop point for the oil/fat material is at least 95° F. (35° C.) and preferably not greater than 140° F. (60° C.). Usually the Mettler drop point is within the range of 100°-135° F. (37.8°-57.2° C.), often at least 110° F. Current preferred oil/fat materials useable according to the principles described herein, have Mettler drop points of 110° F.-135° F. (43.3°-57.2° C.). Some examples according to the descriptions herein would have Mettler drop points no greater than 130° F. (54.4° C.).

The slurry may include a variety of materials in addition to the oil/fat material. It may include for example salt, sweetener, various flavorants, antioxidants; lecithin and/or coloring.

The oil/fat material may comprise a mixture of oil/fat components, having the overall Mettler drop points indicated above. The oil/fat material preferably includes a first oil/fat component comprising at least 32% by weight of the oil/fat material, typically at least 80% by weight of the oil/fat material and usually at least 90% and often at least 95% (in many compositions at least 99%) by weight of the oil/fat material; the first oil/fat component preferably being as characterized herein below. Preferably this first oil/fat component is present within the microwaveable popcorn package at a level of at least 3% by weight of the unpopped popcorn kernels, more preferably at least 8% by weight of the unpopped popcorn kernels and typically and preferably at least 10% by weight of the unpopped popcorn kernels. Typical applications will involve use of the first oil/fat component in the slurry at a level corresponding to 20%-70%, by weight, of the unpopped popcorn kernels.

Three general types of oil/fat components are described as usable, as the first oil/fat component referenced in the previous paragraph. The three general types are: (A) certain types of oil blends including an interesterified oil component; (B) selected physical melt blends of oils, typically with emulsifier; and, (C) selected physical palm oil melt blends.

In general, with the three types of blends, the objective is to develop a first oil/fat material which is relatively stable with respect to problematic levels of undesirable flow (wicking) within the microwaveable popcorn package or undesirable levels of flow (wicking) from the microwaveable popcorn package, in spite of the fact that the first oil/fat material includes a substantial amount of an oil component therein that has a characteristic of being relatively flowable or pourable, under typical conditions of storage such as room temperature. Alternately stated, low trans oils are typically liquid at room temperature, although they may have some solid content. If the liquid oil in the oil/fat material is not modified from this characteristic, the liquid oil will tend to wick undesirably from the package, during storage.

Two general approaches to managing this flow issue are developed herein. In the first, referenced herein as “interesterified blends,” the oil properties are modified through a chemical interesterification processes, to provide for a resulting modified Mettler drop point or melting point profile for the blended oil, and, as a result, a higher stability with respect to undesirable levels of wicking. In the second, referenced herein under the categories Selected Physical Oil Blends and Selected Palm Oil Blends, a solid phase and liquid phase are melt blended together under conditions such that when the mixture is cooled, the solid phase will reform in a manner that defines a matrix that helps trap the liquid oil to inhibit undesirable levels of wicking.

A. Blends Including Interesterified Oil Component.

When the first oil/fat component includes an interesterified oil/fat material, it is generally an oil/fat resulting from an interesterification of a mixture including: a first stearine component; and, an oil having a saturated fat content of no greater than 50% and a Mettler drop point of no greater than 110° F. (43.3° C.), typically no greater than 100° F. (37.8° C.). Typically this oil/fat resulting from interesterification comprises the result of interesterification of a mixture including at least 5%, and not more than 50% by weight, of: (a) the first stearine component typically having a Mettler drop point of at least 130° F. (54.4° C.) and typically not greater than 170° F. (76.7° C.), usually not greater than 165° F. (73.9° C.); and, (b) an oil component having a saturated fat content of no greater than 40% and a Mettler drop point of no greater than 100° F. (37.8° C.). Typically the oil used in the interesterification has a saturated fat content of no greater than 35%, and a Mettler drop point of no greater than 90° F. (32° C.). Indeed, often the oil used in the interesterification will be one which has a Mettler drop point of no greater than 70° F. (21° C.).

In typical applications the component comprising a result of an interesterification comprises a result of interesterification of a blend including: (a) at least 10% and not more than 40%, by weight of a first stearine component; and (b) the oil component as defined. Typically the blend that is subjected to interesterification comprises 15% to 30%, by wt., stearine.

For the component comprising a result of interesterification, preferably the first stearine component is selected from the group consisting essentially of soybean stearine, cottonseed stearine, corn stearine, palm stearine and mixtures thereof. Typically it comprises soybean stearine, for cost.

The interesterification process can be a directed interesterification, but that is not required or even preferred.

The oil component from which the interesterified oil is formed is an oil having: (a) a saturated fat content of no greater than 50% (typically no greater than 40% and usually no greater than 30%); and, (b) a Mettler drop point of no greater than 110° F. (43.3° C.), typically no greater than 100° F. (37.7° C.) and usually no greater than 90° F. (32° C.), is typically and preferably selected from the group consisting essentially of soybean oil, canola oil, sunflower oil, corn oil, rapeseed oil, cottonseed oil; mid-oleic sunflower oil, safflower oil; partially hydrogenated one(s) of the identified oils, or mixtures of one or more of the identified oils and/or one or more of the identified partially hydrogenated oils. Preferably, any partially hydrogenated oil that is used, has an iodine value of at least 90. Most preferably this oil component, for use in the interesterification, comprises soybean oil that has not been hydrogenated at all, or which has an iodine value of at least 110, typically within the range of 120-145, inclusive.

The first oil/fat component of the oil/fat in the slurry may comprise 100% of the result of the interesterification. However in some instances the first oil/fat component will comprise a mixture of: (a) the result of the interesterification; and (b) a second stearine component. When this type of mixture or blend is used as the first oil/fat component preferably it is made with at least 1%, typically at least 2% and usually no more than 10% (by wt.) of the second stearine. Typically no more than 5% (by wt.) of the second stearine is used; the remainder comprising the result of the interesterification, as defined. The second stearine typically has a Mettler drop point of at least 130° F. (54.4° C.) and typically not greater than 170° F. (76.7° C.). Usually the Mettler drop point is no greater than 165° F. (73.9° C.). The second stearine is typically selected from the group consisting essentially of cottonseed stearine, soybean stearine, corn stearine, palm stearine or mixtures thereof. Usually it comprises soybean stearine.

The first stearine as defined above and the second stearine as defined above can be independently selected. The same stearine can be used for both, if desired.

The interesterified blends characterized above, generally result in the provision within a microwave popcorn bag of an oil/fat material which has a relatively low trans content, as a result of it being developed from oil material(s) that is low in trans, but yet which shows a melting point profile or Mettler drop point profile that is more acceptable for incorporation in package microwave popcorn products on a substantial basis, with respect to storage stability and heat characteristics.

B. Selected Physical Oil Blends.

When the first oil/fat material is a physical oil blend, it is typically a result of melt blending which has: (a) an overall saturated fat content of no greater than 50% (preferably no greater than 44% and most preferably no greater than 38%); and, (b) an overall Mettler drop point of no greater than 145° F. (62.8° C.), more preferably no greater than 140° F. (60° C.) and most preferably no greater than 135° F. (57.2° C.).

The physical oil blends according to the present disclosure typically comprise a result of melt blending: (a) liquid oil component; and, (b) solid fat component.

Typically the Mettler drop point of the blend is at least 100° F., usually at least 110° F. (43.3° C.), sometimes 115° F. (46.1° C.) or more. For example a Mettler drop point of 125°-135° F. (51.7°-57.2° C.) can be obtained within the following teachings by melt blending: corn oil (85% by wt.); soybean stearine (10% by wt.) and mono-glycerides (5% by wt.).

The liquid oil component, is a component that generally indicates liquid properties at room temperature, for example, it is pourable at room temperature (70° F. for 21.1° C.). Oils which meet this definition typically have one or both of the following criteria: (a) a solid fat content (SFC) of no greater than 30%, at 70° F. (21.1° F.); and (b) a Mettler drop point of no greater than 90° F. Although palm oil (palm fruit oil) does not necessarily meet both of these criteria, the other liquid oils identified within this section would. The liquid oil component generally has a Mettler drop point of no greater than 106° F. (41.1° C.), typically (as mentioned) no greater than 90° F. (32.2° C.) and often a Mettler drop point of room temperature (70° F. or 21.1° C.) or below.

The solid fat component is typically a material that exhibits the properties of a solid at room temperature. The solid fat component typically has a Mettler drop point of at least 130° F. (54.4° C.) and typically not more than 170° F. (76.7° C.). Usually it has a Mettler drop point of no more than 165° F. (73.9° C.).

It has been found that when the two (liquid oil component and solid fat component) are melt blended together, upon cooling an oil/fat material or blend results, in which the matrix of the solid fat material helps retain the liquid material from undesirable levels of wicking from a microwave popcorn package.

The liquid oil component is typically selected from the group consisting essentially of soybean oil, canola oil, sunflower oil, corn oil, rapeseed oil, cottonseed oil; safflower oil; partially hydrogenated one(s) of the identified oils, mixtures of one or more of the identified oils, mixtures of one or more of the identified partially hydrogenated oils, mixtures of one or more of the identified oils and/or identified hydrogenated oils, and/or mixtures of one or more of the identified oils and/or hydrogenated oil, optionally including up to 49%, by wt., palm oil (sometimes called palm fruit oil). By this latter, it is meant that the liquid oil component can contain up to 49%, by wt., palm oil, although in some instances it will be preferred to have no palm oil for nutritional reasons related to minimizing saturated fat levels.

Preferably, if partially hydrogenated oil is used for the oil component, it has an iodine value of at least 90. Most preferably the oil component comprises an oil which contains less than 3% linolenic, such as cottonseed and/or corn oil that has not been hydrogenated at all, or which has an iodine value of at least 110, typically within the range of 120-145, inclusive.

The solid fat component is typically and preferably selected from the group consisting essentially of soybean stearine, cottonseed stearine, corn stearine, palm stearine, hydrogenated palm stearine, hydrogenated palm fruit oil and mixtures thereof. Usually the solid fat component is soybean stearine.

In many instances, the melt blend will further include an additional mouth feel adjuvant: (a) which provides assistance with control of the wicking or flow of liquid oil component; and, (b) which helps improve mouth feel of the resulting product. The materials which operate as adjuvants in this regard, are typically materials that are solid at room temperature, but which can be melt blended. Preferably this adjuvant material is not triglyceride material. Edible materials often marketed as emulsifiers are useable, in spite of the fact that they are not selected (at least with respect to the steps of melt blending), for their characteristics as emulsifiers. When present, this adjuvant is typically present at a level sufficient to provide an effective amount of improvement in mouth feel, relative to its absence in the composition. Typically when used, this amount will be on the order of at least 0.5% by weight of the liquid oil component, solid fat component and mouth feel adjuvant together, in the melt blend. Usually this adjuvant will not be present at no more than 7% by weight of the total weight of the melt blend (oil; solid fat component; and adjuvant component for improvement of mouth feel). A typical amount will be on the order of 1%-6%, by wt.

The mouth feel adjuvant, when used, is typically and preferably selected from the group consisting essentially of mono-glycerides, di-glycerides, mixtures of mono and di-glycerides, polyglycerol esters of fatty acids, partially hydrogenated monoglycerides, propyleneglycol esters of fatty acids and mixtures thereof. Often, commercially available mixtures of fully hydrogenated mono-glycerides, usually sold as emulsifiers, will be used.

When this type of mixture is melt blended for use in a packaged microwaveable popcorn product as the first oil/fat component, preferably it is made with: at least 80% and no more than 95% (by wt.) of the liquid oil component; at least 5% and no more than 15% (by wt) of the solid fat component; and, if present, 0.5%-7%, by wt., mouth feel adjuvant.

Herein above it was indicated that this oil/fat component can be made from a melt blend wherein the liquid oil component used comprises up to 49% by wt. palm oil. Palm oil will lead to an increase in total saturated fat levels. However it can be accommodated in the compositions, as previously indicated, if desired.

C. Selected Palm Oil Blends.

In this section, selected palm oils blends which can provide for satisfactory performance with respect to wicking characteristics in packaged microwave popcorn products are described. These materials are typically higher in saturated fat contents, than the selected physical oil blends characterized in the previous section.

When the first oil/fat component is a palm oil blend, it is typically a palm oil blend having: (a) a saturated fat content of no greater than 60% (preferably no greater than 55% and most preferably no greater than 53%); and, (b) a Mettler drop point of at least 100° F. (37.8° C.), typically at least 110° F. (43.3° C.) and no greater than 125° F. (51.7° C.), usually no greater than 120° F. (48.9° C.) and often no greater than 118° F. (47.8° C.).

The palm oil blend is typically a melt blend of: (a) first liquid palm oil component (Mettler drop point no greater than 106° F. (41.1° C.)); and, (b) a second solid palm oil/fat component having a Mettler drop point of at least 120° F. (48.9° C.), typically at least 130° F. (54.4° C.) and usually not greater than 145° F. (62.8° C.). The second, solid, palm oil/fat component is typically selected from the group consisting essentially of: palm stearine, fractionated palm stearine, hydrogenated palm oil or mixtures thereof. The second, solid, palm oil/fat component is typically palm stearine.

The first liquid palm oil component typically is selected from the group consisting essentially of palm fruit oil (sometimes called palm oil herein), palm olein and mixtures thereof. Typically it comprises palm fruit oil.

When this type of mixture or blend is used as the oil/fat component preferably it is made with at least 10% and no more than 60% (by wt.) of the second, solid, palm oil/fat component, more preferably at least 15% and no more than 50% (by wt.); the remainder (40%-90%, typically 50%-85%, by. wt.) comprising the first, liquid, palm oil component, as defined. The typical preferred melt blends of the second, solid, palm oil/fat component and first liquid palm oil component will yield a Mettler Drop Point of 110° F. (43.3° C.) to 120° F. (48.9° C.) with a saturated fat level between 60% and 50%.

D. Further Regarding the Typical Oil Blends.

Without regard to which of the above three types of oil/fat materials (or a mixture) is used, the oil/fat material of the oil/fat slurry may comprise 100% of the first oil/fat component. However, there is no specific requirement that it do so. As indicated, it will be advantageous (for certain applications), for the oil/fat material of the oil/fat slurry to include at least 80% by weight of the first oil/fat component as defined, more preferably at least 95% (by wt.) of the first oil/fat component as defined; most preferably at least 99% of the first oil/fat component, as defined.

It is noted that in some instances it may be desirable to not only provide the first oil/fat component in the form of a low trans material, but also in the form of a material having a low saturated fat content. When this is intended, the material would typically be chosen from the interesterified oil blends and physical oil blends discussed above, and not the palm oil blends or blends including liquid palm oil.

In many instances the oil/fat material would be provided in a form, i.e., either when made or when blended into a slurry for inclusion of microwave popcorn packaging, including an effective amount of antioxidant, as mentioned above. A typical antioxidant would be TBHQ (tert-butyl hydroxy quinone), useable for example, at 200 ppm. TBHQ is available in tenox 20 from Amerol, Farmingdale, N.Y. 11735. A variety of alternatives (for example mixed tocopherols) are possible.

### II. Preferred Characteristics of the Fat/Oil Composition

A. Nutritional Characteristics.

1. Low Trans Fatty Acid Contents.

Using the principles characterized in Section I above, with respect to selection of an oil/fat component in a slurry of a microwaveable popcorn composition, preferred nutritional characteristics can be provided in the resulting microwave popcorn process. For example, even though the overall microwave popcorn slurry typically contains at least 10% by weight oil/fat material, and indeed preferably 30%-70% by weight oil/fat material, it can be provided such that the total trans fatty acid presence is no greater than 5% by weight, of the oil/fat component. Preferred oil/fat components that meet this definition, even when used in amounts on the order of at least about 32 grams (per package in a microwave popcorn product) and with at least 60 grams of unpopped popcorn kernels in the package, can be used in amounts that allow for a level of trans fatty acids per popcorn serving of less than 0.5 grams per serving.

2. Saturated Fat Contents.

a. Low Saturated Fat Contents.

Certain preferred compositions provide for a low total saturated fat content as well. The principles characterized above can be used to provide a total saturated fat content that is no greater than 40%, preferably no greater than 35%, based on total oil/fat weight in the popcorn composition when evaluated by GLC analysis, even though the composition includes stearine/fully hydrogenated oil. Thus, with some arrangements a saturated fat content of no greater than 14%, preferably no greater than 12%, based on total food product composition; and, a saturated fat content no greater than 5 g/serving and preferably no greater than 4 g/serving, can be achieved. This is done by selecting the first oil/fat component from either or both of the interesterified blend or the physical oil blends discussed above. When one of the physical oil blends is used, it will be preferred to avoid ones that include palm oil if present at all, above a minimal level.

b. Other Saturated Fat Contents.

When the selected palm oil blends are used, the saturated fat content will typically be higher. With the palm oil blends, the principles characterized above can be used to provide a total saturated fat content that is no greater than 60%, preferably no greater than 55%, based on total oil/fat weight in the popcorn composition when evaluated by GLC analysis. With the palm oil blends, a saturated fat content of no greater than 19%, preferably no greater than 17%, based on total food product composition; and, a saturated fat content no greater than 7 g/serving and typically no greater than 6 g/serving, can be achieved.

B. Other Properties.

1. Mouthfeel.

The most desirable compositions characterized herein, provide for an acceptable mouthfeel in use. Mouthfeel is typically an issue relating to such factors as: (a) melting point range; and (b) highest melting or softening point.

The preferred compositions characterized herein can be formulated to have acceptable and desirable mouth feel characteristics, for a typical consuming public. This is because the first oil/fat component can be made to have a Mettler drop point (melting point) within the range of 110° F.-145° F. (43.3°-62.8° C.), typically 115° F.-135° F. (46.1-57.2° C.) while at the same time imparting an acceptably low level of mouthcoat.

Mouthfeel refers to the texture of food as sensed in the mouth during consumption of the food item. Mouthfeel is an important characteristic in determining acceptance by consumers. Mouthfeel can encompass many characteristics such as crispness, hardness, graininess and mouthcoat. Mouthcoat refers to the food residue left on the surfaces of the mouth (especially roof of mouth and tongue). Aspects of mouthcoat include the perceived amount of residue (i.e. thick layer, thin layer), texture of residue (i.e. slippery, waxy, sticky), duration of residue (quickly disappears or lingers). Consumption of microwave popcorn can leave a mouthcoat that is often due in large part to the slurry component of the microwave popcorn. Oil is often a major component of the slurry and can therefore impact the mouthfeel. For example, a pure liquid oil or an oil system containing emulsifiers often leaves a slippery mouthfeel. An oil with a melt point above body temperature often leaves a waxy mouthfeel. A waxy mouthfeel is considered an undesirable characteristic of microwave popcorn.

2. Desirable Wicking Characteristics.

An advantage to the principles characterized herein, is that the slurry in the microwave popcorn bag can be made in a form less likely to exhibit undesirable levels of wick through popcorn packaging, at typical handling storage temperatures, than liquid oils.

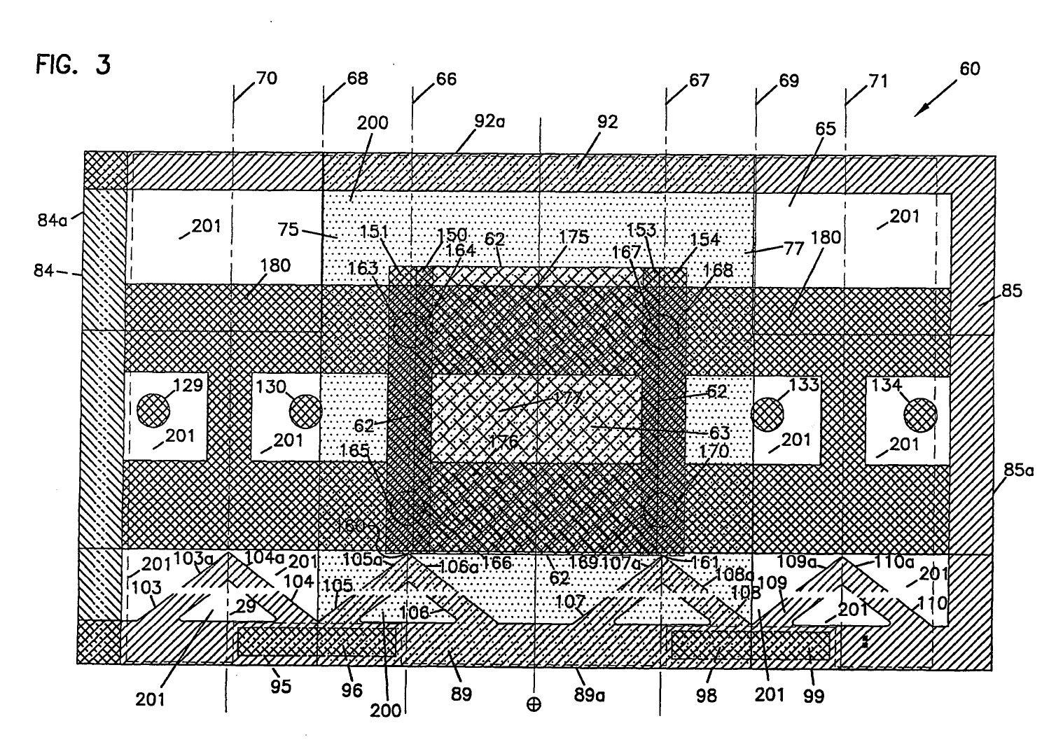

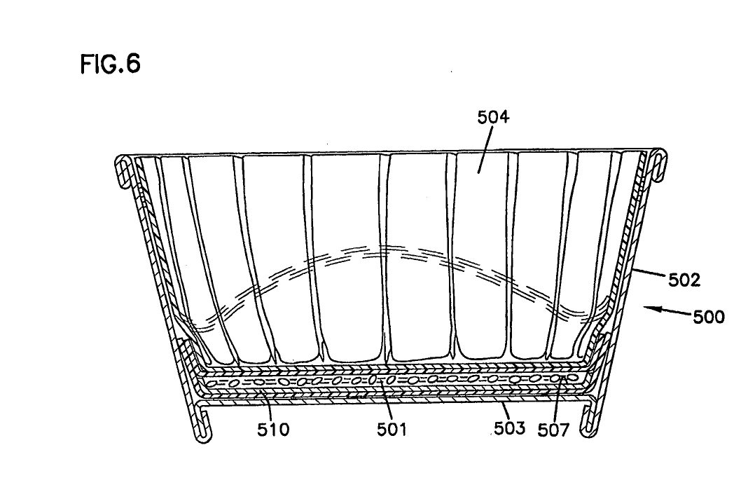

The preferred compositions can be used in a variety of prior art popcorn bags, for example those constructed using fluorocarbon treated paper. Examples of useable constructions are described in U.S. Pat. Nos. 5,044,777; 5,081,330; 6,049,072; 5,195,829; and, 6,396,036, incorporated herein by reference. The compositions can also be incorporated into tub products, for example as described in U.S. Pat. Nos. 5,008,024; 5,097,107 and 5,834,046, incorporated herein by reference. An example is provided in connection with FIG. 6 of this disclosure. In FIG. 6, a tub product 500 is depicted with a microwave popcorn composition 501 positioned as located. The tub is generally described in U.S. Pat. No. 5,834,046, particularly in FIG. 3, the entire patent being incorporated herein by reference.

Referring to FIG. 6, the tub 500 has a rigid sidewall 502, base 503 and a cover 504. The popcorn charge 501 is positioned in pouch 507. During use, the pouch opens, and the cover 504 balloons as the popcorn expands and steam is released. The arrangement 500 includes a microwave interactive construction 510 to facilitate popping.

In addition to the prior art packaging characterized above, compositions can be used in newly developed packaging. Examples include those described in U.S. Provisional application 60/544,873, filed Feb. 13, 2004; U.S. Provisional application 60/588,713, filed Jul. 15, 2004; U.S. Provisional application 60/647,637, filed Jan. 26, 2005; PCT US 05/04249 filed Feb. 11, 2005; and U.S. Provisional application 60/574,703, filed May 25, 2004, filed as PCT US 05/08257 filed Mar. 11, 2005, these six references being incorporated herein by reference.

Some example packaging arrangement possibilities are characterized herein below.

### III. Additional Considerations

### A. Preparation of the Interesterified Oils.

Above, it was indicated that the first oil/fat component could be a result of an interesterification of a mixture of a non-hydrogenated oil and stearine component. A variety of techniques for interesterification, both chemical and enzymatic are known and can be applied. For the preferred compositions characterized herein, there is no preference with respect to whether a chemical or enzymatic interesterification is used.

Interesterification is a reaction that involves the exchange of acyl groups among triglycerides. The reaction can include the interchange of acyl groups between a fatty acid and a triacylglycerol (acidolysis), an alcohol and triacylglycerol (alcoholysis), and an ester with another ester, referred to as interesterification, ester interchange, proper esterification, rearrangement, or transesterification. During an interesterification process, fatty acids are rearranged both within triacylglycerol molecules (intramolecular) and between different molecules (intermolecular). The reaction is performed in order to modify the functional properties of lipids and not the specific fatty acids. Only the positions of fatty acid groups are changed, not their properties. Unsaturation levels stay the same and there is no cis-trans isomerization such as occurs in hydrogenation. Interesterification is used to change the physical melting and crystallization properties of lipids. The final resulting properties are dependant on the composition of the starting materials. It is often utilized to alter blends of lipids having different melt points, such as a liquid oil and a solid fat.

Interesterification can be performed using either a chemical or enzymatic catalyst. Alkaline catalysts, such as sodium methoxide, are generally preferred for chemical interesterification. Lipases are used as the catalyst for enzymatic interesterification. Lipases vary in their specificity. They can be specific according to the following: substrate, fatty acid, positional esters, and stereospecific (for example, random and sn-1,3specific). Most lipases preferentially hydrolyze at the 1- and 3-positions on the triglyceride, although some can react at all three positions. An example of an industrial application of this process is used in providing the NovaLipid™ line of oils supplied by Archer Daniels Midland (ADM), Decatur, Ill. in which an immobilized 1,3-specific lipase from Thermoces languinosus, named Lipozyme TL IM (Novozyme A/M Bagsvaerd, Denmark) is used as the catalyst (Reference: Cowan, D and T L Husum, Enzymatic interesterification: Process advantage and product benefits, Inform, March 2004, Vol 15(3), p. 150-151).

Typically, an interesterified oil consistent with the parameters defined herein can be obtained by order from a food oil supplier such as ADM.

### B. Preparation of the Selected Physical Oil Blends.

When the first oil/fat component is a physical oil blend as described above, it is typically produced by physically blending fully melted components: liquid oil component, solid fat component, and, if present, emulsifier, as previously defined.

### C. Preparation of Selected Palm Oil Blends.

When the first oil/fat component is a palm oil blend, it is typically prepared by blending the fully melted whole or fractionated palm oils together, without emulsifier. Herein the term “palm fruit oil” refers to the whole, or non-fractionated oil derived from the palm fruit. Fractionation is a physical process that separates oil based on melting point. The lower melting point fraction is commonly referred to as the olein fraction while the higher melting point fraction is commonly referred to as the stearine fraction. The olein fraction has a lower saturated fat content than the stearine fraction.

### D. Example Materials and Formulations.

1. Example Conditions When The First Oil/Fat Component is the Interesterified Blend.

The slurry is prepared by using a fully melted oil held at a minimum temperature of 120° F. (48.9° C.). The oil (supplied by Archer Daniels Midland) is comprised of a physical blend of 96% interesterified oil and 4% soybean stearine. The interesterified oil is produced by enzymatically interesterifying a mixture of 80% soybean oil and 20% soybean stearine. The enzyme used in the interesterification process is a 1,3 stereospecific lipase. Salt, sweetener and/or other flavors, and/or color is added to the oil and mixed until equally distributed to make the slurry. Popcorn is dispensed into the microwaveable bag followed by dispensing of the slurry. (Antioxidant may be in the oil when obtained, or can be added during slurry formation.)

2. Example Conditions when the first oil/fat component is one of the selected physical oil blends.

The slurry is prepared by using a fully melted oil blend. An example slurry would include 82-88% by wt. oil selected from corn oil, cottonseed oil or mixtures thereof; 7-13%, by wt., soybean stearine; and, 2-7%, by wt., mono-glycerides. Salt, sweetener and/or other flavors, and/or color, and/or antioxidants are added to the oil and mixed until equally distributed to make the slurry. Popcorn is dispensed into the microwaveable bag followed by dispensing of the slurry. (The antioxidant may alternatively be in the oil as provided by the oil supplier.)

3. Example conditions when the first oil/fat component is one of the selected palm oil blends described.

The slurry is prepared by using a fully melted oil blend. Example slurries would include 75-85%, by wt., palm oil and 15-25%, by wt., palm stearine. Salt, sweetener and/or other flavors, and/or color and/or antioxidants are added to the oil and mixed until equally distributed to make the slurry. Popcorn is dispensed into the microwaveable bag followed by dispensing of the slurry.

4. Example Formulae.

### Example Formula a: Butter Flavored Popcorn

| Ingredient | g/Bag |
|---|---|
| Popcorn | 65.3 |
| Oil (First oil/fat component) | 30.72 |
| Extra Fine Salt | 2.78 |
| Butter Flavor | 0.43 |
| Annatto Color | 0.04 |

### Example Formula 2: Light Butter Flavored Popcorn

| Ingredient | g/Bag |
|---|---|
| Popcorn | 71.4 |
| Oil (First oil/fat component) | 11.07 |
| Extra Fine Salt | 2.30 |
| Butter Flavor | 0.30 |
| Annatto Color | 0.04 |

### IV. Example Microwave Popcorn (Flexible) Packages

Microwave popcorn arrangements using bags, generally involve a collapsed package, having a microwave interactive sheet or susceptor operably positioned therein, and with a microwaveable popcorn charge positioned in a covering relation or thermoconductive relation to the microwave interactive construction. For many conventional bag arrangements, the package is generally folded into a tri-fold configuration during storage and prior to use. The tri-fold is typically positioned in a moisture barrier overwrap to enhance shelf life for the contents.

The microwave popcorn charge will generally comprise at least 50 grams of unpopped popcorn kernels and at least 20 grams of oil/fat, typically having a melting point (Mettler drop point) of at least 100° F. (37.8° C.), usually at least 110° F. (43.3° C.) and typically under 145° F. (62.8° C.), usually under 135° F. (57.2° C.). Often the popcorn charge contains at least 60 grams of unpopped popcorn kernels and at least 25 grams (in non-light oil products) of oil/fat; the oil/fat again having a melting point for Mettler drop point as described.

In the following table, some examples for different sized bags, are provided. The % are stated relative to all edible components in the bag. Three sizes of bags are defined: “mini,” “big” and “std” or standard (i.e., middle sized). For each, a typical minimum amount of oil/fat (according to the present disclosure) and corn presence, by wt. is provided, as well a typical minimum level of oil/fat (according to the present disclosure) by wt. % of edible components. Also, for each a typical amount of corn and oil/fat (according to the present disclosure) is defined. For the “std” a typical light oil level is also provided. The oil/fat would typically be 100%, by wt., a first oil/fat component as described above. However, again, some variations are possible, as described.

| | | | | Wt % Oil/Fat |
|---|---|---|---|---|
| Bag | Preference | Corn | Oil/Fat | per bag |
| Mini | At least | 20 g | 5 g | 20% |
| Mini | Typically | 28 g | 15 g | 35% |
| Big | At least | 90 g | 10 g | 10% |
| Big | Typically | 105 g | 50 g | 31% |
| Std | At least | 50 g | 20 g | 28% |
| Std | Typically | 60 g | 25 g | 29% |
| Std | Light oil level | 70 g | 12 g | 15% |
| | (typically) | | | |

Certain package arrangements described in the references cited above, generally involve folded paper constructions in which creases or folds are used along the paper, at opposite side edges where side gussets are attached to (or are integral with) two opposite face panels. One pair of opposite edge folds is generally located on opposite sides of a first face panel in one tube of the bag, with a second pair of opposite edge folds at opposite sides of a second face panel in an opposite, second, tube. During initial loading of a popcorn charge into the bag, the popcorn charge is generally placed in one of the two tubes, against a portion of a panel between the creased or folded side edges.

Creasing of a paper at folds sometimes results in microfracture of the paper integrity, along the edge of creasing. If the popcorn charge is allowed to come into direct contact with a creased location, several problems can occur. First, during manufacture, shipping, storage and handling (depending on the content of the microwave popcorn charge), undesirable levels of leakage or wicking of oil/fat material (especially with liquid oils) through the paper material in the location of the creased edges can occur. Secondly, during microwave popping, undesirable levels of leakage or wicking of oil/fat can occur along this same creased location, again especially with liquid oils. Even with the improved highly refined papers characterized herein, such creasing can be expected to lead to some disadvantage.

In microwave popcorn packaging, leakage or wicking adjacent to selected creases or folds in the microwave popcorn construction, can be better managed, if desired, than with conventional arrangements. In some arrangements, this can be managed by providing specific seal patterns or arrangements within the packaging. In some instances it can be managed by applying a material at selected regions on an interior of the package, to affect surface tension between oil and the internal ply of paper. For this latter, the same type of material (adhesive) as used for the seals, can be used. In some arrangements, both techniques can be used.

Some advantageous arrangements are described for example in PCT application US 05/04249 filed Feb. 11, 2005, the complete disclosure of which is incorporated herein by reference. The bag arrangements briefly discussed below, are described in that PCT application.

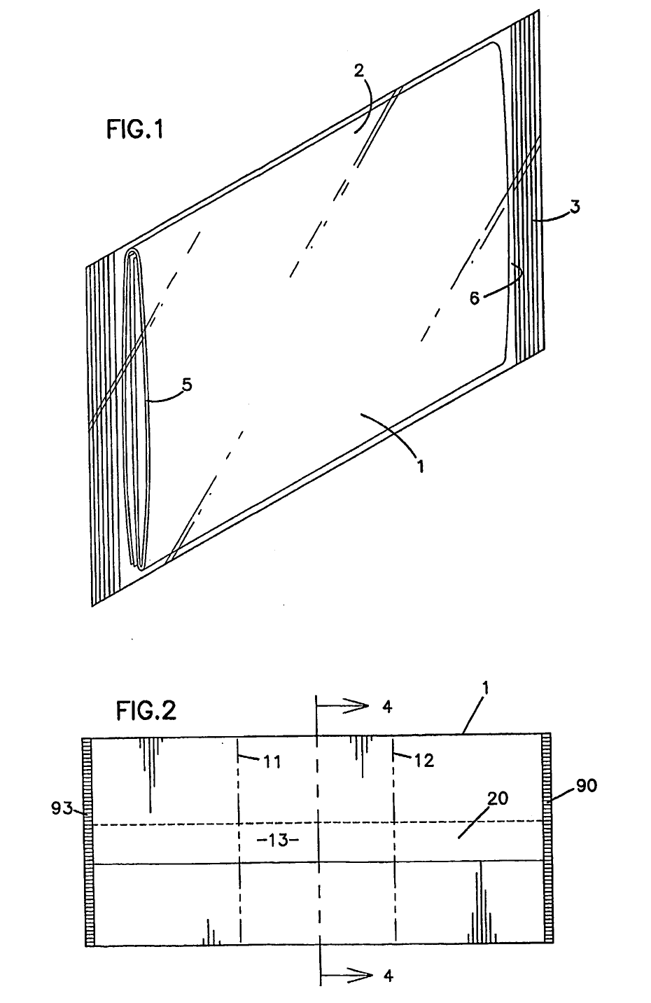

B. The Arrangement of FIGS. 1-5.

The reference numeral 1, FIG. 1, depicts a microwaveable popcorn package according to the present disclosure. In FIG. 1, the popcorn package 1 is depicted in a conventional “tri-fold” configuration 2, for storage. In FIG. 1, the tri-fold 2 is sealed within a storage overwrap 3. A useable storage overwrap 3 would comprise a 90-140 gauge, biaxially oriented, polypropylene, although other materials can be used. The overwrap 3 is discarded, when the popcorn package 1 is removed from storage, for use.

In FIG. 1, the package 1 is shown stood up on edge, as it could be when stored, although alternatives are possible.

Still referring to FIG. 1, the package 1 has two opposite sides 5, 6; each side 5, 6, as discussed in detail below, comprising two side gusset outside edges, along which creases are located.

As indicated, the arrangement depicted in FIG. 1 is a “tri-fold.” The invention is described and depicted in connection with an arrangement folded, or intended to be folded, as a tri-fold. It will be apparent, however, that the techniques according to the present disclosure can be utilized in other folded arrangements, i.e., even when the arrangements are not folded as “tri-folds,” for storage.

In FIG. 2, a top plan view, package 1 is schematically shown in an unfolded configuration oriented much as it would be when positioned in a microwave oven for popping of an internally received popcorn charge, but before expansion. In FIG. 2, lines 11 and 12 indicate fold lines which define central region 13 in the arrangement and which formed the folds to make the tri-fold, FIG. 1. In central region 13, the unpopped popcorn charge will generally be positioned in an orientation against, and when oriented as shown in FIG. 2 above, a portion of the bag 1 in which a microwave interactive construction is preferably positioned. Herein, in this context, the term “microwave interactive” is meant to refer to a material which absorbs energy and becomes hot, upon exposure to microwave energy in a microwave oven.

During the popping operation, moisture inside the popcorn kernels absorbs microwave energy, generating sufficient steam and heat for popping and expansion of bag 1. In addition, the microwave interactive material absorbs microwave energy and dissipates heat to the popcorn charge. In preferred constructions, the microwave interactive material occupies at least central region 13 (internally) and is in greater thermoconductive contact with a portion of that region than any other portions of an interior of popcorn package 1. That is, most of the microwave interactive material (by area or weight) is positioned in thermoconductive contact with a region of the bag interior whereat the microwave interactive will be covered by the popping charge, when the package 1 is positioned in a microwave over for material use. This is preferred, since it leads to a preferred and efficient utilization of microwave interactive material and also due to preferred heat transfer or heat retention characteristics in connection with the popcorn popping process. This technique is also used in conventional arrangements, such as those of certain ones of the incorporated references.

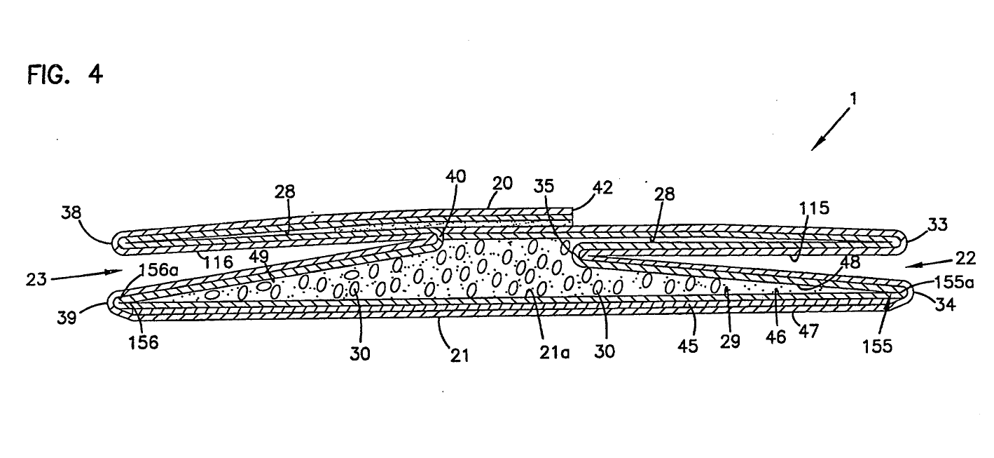

Attention is now directed to FIG. 4, a cross-section taken generally along line 4-4, FIG. 2. From a review of FIG. 4, it will be understood that the popcorn package generally comprises a construction defining first and second opposite face panels 20, 21 joined by first and second, opposite, inwardly directed side gussets 22, 23. By “inwardly directed” in this context it is meant that, in the cross-section of FIG. 4, gussets 22, 23 point or extend toward one another.

The gussets 22 and 23 generally separate popcorn package 1 into first and second expandable tubes 28 and 29. A popcorn charge 30 is substantially positioned and substantially retained within one of the tubes, in this instance tube 29. The other tube, tube 28, prior to popping, is generally collapsed. Indeed, in preferred arrangements, tube 28 is sealed closed by temporary heat seals, prior to the popping operation.

Still referring to FIG. 4, side gusset 22 generally comprises: outwardly directed edge creases or folds 33 and 34, fold 34 being adjacent face panel 21 and fold 33 being adjacent face panel 20; and, inwardly directed, central, fold 35. Similarly, gusset 23 comprises: outwardly directed edge creases or folds 38 and 39; and, inwardly directed central fold 40; fold 39 being adjacent face panel 21 and fold 38 being adjacent face panel 20. Construction 1, for the arrangement shown in FIG. 4, is folded from a two ply sheet of material, and panel 20 includes central longitudinal seam 42 therein. Such folds as folds 33, 34, 35, 38, 39 and 40 are known for flexible microwave packaging, for example as shown in U.S. Pat. Nos. 5,044,777; 5,195,829; and, 5,650,084.

Underneath popcorn charge 30, arrangement or package 1 includes microwave interactive construction or susceptor 45. The microwave interactive construction or susceptor 45 may be of a conventional design. In certain arrangements, such as the one shown in FIG. 4, the susceptor 45 is positioned between layers or plies 46, 47 from which the flexible construction 1 is folded. A typical microwave interactive construction comprises a flexible, metallized polyester sheet. Even with the susceptor 45 positioned between sheets 46, 47, the arrangement 1 is referenced as two-ply. In the arrangement shown, the susceptor 45 only occupies a portion of the area between the plies 46, 47.

Still referring to FIG. 4, in region 21a an inside surface of panel 21 is shown. Region 21a defines an unpopped popcorn charge retention surface. This is because the unpopped popcorn charge 30 is generally positioned in contact with surface 21a, and generally sitting on surface 21a, when the package 1 is positioned in a microwave oven, for popping. Referring to FIG. 4, the gusset 23 includes a panel section 49, adjacent to, and integral with, face panel 21; and, gusset 22 includes panel section 48 adjacent to, and integral with, face panel 21.

Attention is now directed to FIG. 3. In FIG. 3, a top plan view of a bag blank, panel or sheet 60 from which an arrangement according to FIG. 1 and can be folded, is shown. Many of the features illustrated in FIG. 3 are generally analogous to features shown and described in U.S. Pat. Nos. 5,195,829; 5,044,777; and 5,650,084. As will be discussed in detail below, a variety of sealant arrangements are utilized to provide for desirable features in the bag construction 1. Various combinations of these can be implemented, as well as variations, as desired. The sealant fields indicated are meant to provide examples of useable arrangements.

As will be apparent from the following descriptions, in FIG. 3 various sealant fields are indicated that can be alternatively or optionally used, to provide desirable arrangements. This will be understood from further descriptions below.

The view in FIG. 3 is of what is sometimes referred to as the “backside” of sheet 60; i.e., the side 65 of sheet 60 that forms the interior surface of the assembled bag construction 1, FIG. 1. The side opposite the side viewable in FIG. 3 is sometimes referred to as the “front side,” and will form the exterior surface of the bag construction 1. Of course a mirror image arrangement is also possible.

Still referring to FIG. 3, line segment 62 defines a region 63 within which, for preferred embodiments, most of the microwave interactive material, such as a microwave interactive material and construction 45, FIG. 4, would be associated. The microwave interactive construction, for example interactive construction 45, FIG. 4, may be positioned on an interior of the arrangement, an exterior, or between plies 46, 47. In general, for preferred embodiments, microwave interactive construction 45 is positioned between plies 46, 47 of the blank 60.

Still referring to FIG. 3, again the surface 65 viewed is the surface which, when package 1 has been folded, forms the interior surface of the construction 1. The popcorn charge 30, FIG. 4, then, will eventually be positioned over central region 63.

Still referring to FIG. 3, line 66 generally indicates where fold 34, FIG. 4, will be formed; and, line 67 generally indicates where fold 39, FIG. 4, will be formed. Folds or creases 34, 39 are generally outwardly directed folds or creases in opposite side gussets 22, 23 adjacent one face 21. Surface 21a, for positioning of a popcorn charge thereon, in use, extends between the folds 34, 39. Line 68 corresponds with fold 35 (FIG. 4); line 69 with fold 40 (FIG. 4); line 70 with fold 33 (FIG. 4); and, line 71 with fold 38 (FIG. 4). Thus, region 75, between fold lines 68 and 66, will generally define gusset panel section 49, FIG. 4; and, region 77 between fold lines 67 and 69 will generally define gusset panel section 48, FIG. 4.

In general, the tri-fold, FIG. 1, is eventually formed by folding the overall arrangement 1 such that it folds along appropriately spaced perpendicular to lines 66, 67, 68, 69, 70, 71. It will be understood that this latter folding would generally be after the bag construction, FIG. 2, has been otherwise assembled.

Referring to FIG. 3, sealant field 84, along edge 84a positioned an opposite side of panel 60 from side 65, is used to engage field 85 along edge 85a, during folding (typically with applied heat and pressure), to form the longitudinal seam or seal 42, FIG. 4. It will also be apparent that, during folding, various portions of field 89 along edge 89a on side 65 will line up with one another to form various portions of end seal 90, FIG. 2 (typically with application of heat and pressure); and, various portions of field 92, along edge 92a on side 65, FIG. 3, will line with one another to form end seal 93, FIG. 2, typically with application of heat and pressure. In general, field 92 will form a top edge 93 of the completed bag, through which popped popcorn is removed, after popping. Sealant fields 95 and 96, on the opposite side of the panel 60, FIG. 3, will align with one another, when folding around fold line 68 is conducted, and heat and pressure are applied, to help secure panel 60 in a preferred configuration, along end 90, FIG. 2, after folding. This is analogous to what was done in the arrangement of U.S. Pat. No. 5,195,829, FIG. 1a. Similarly, sealant fields 98 and 99, on underside of panel 60, FIG. 3, are aligned with one another when the panel is folded around fold line 69, also to provide a secure end and preferred end configuration to end 90, FIG. 2, when heat and pressure are applied.

Attention is now directed toward sealant fields 103, 104, 105, 106, 107, 108, 109 and 110. Analogous fields were shown in U.S. Pat. No. 5,195,829. During folding, portions of fields 103-110 align with one another to retain selected portions of the panel adhered to one another (typically after application of pressure and heat) to provide for preferred configuration during expansion. In particular, field 103 engages field 104; field 105 engages field 106; field 108 engages field 107; and, field 110 engages field 109, during folding and after pressure and heat application. Engagement between fields 105 and 106, and also between fields 108 and 107, tend to retain selected portions of panels 48 and 49 against panel 21, FIG. 4, in regions where the popcorn charge is not located in the collapsed fold or tri-fold 2 (FIG. 1). Sealant field 103 folded and sealed against field 104, and field 110 folded against field 109, help retain panels 115 and 116 seal against panel 20, FIG. 4, in the collapsed tri-fold. This helps ensure that the popcorn charge 30, FIG. 4, is retained where desired in the arrangement. Advantages from this are described, in part, in U.S. Pat. No. 5,195,829.

Still referring to FIG. 3, fields 103a, 104a, 105a, 106a, 107a, 108a, 109a, 110a indicate optional extensions to fields 103, 104, 105, 106, 107, 108, 109, 110, respectively, to create a V- or chevron shape to the overlapping seals. These can be and have been used in popcorn packaging, as indicated in U.S. Pat. No. 5,195,829. However the optional portions 103a-110a can be avoided to advantage, if desired. This is in part because extensions 103-110 project at an angle appropriate to generate the desirable resulting seal in the folded arrangement, without necessarily using the complete chevron shape.

It is noted that for the bag arrangement of U.S. Pat. No. 5,195,829 chevron fields adjacent region 92 were also used, to advantage. For the particular arrangements reflected by FIG. 3, these were not shown. It is expected that such fields would not be used in preferred arrangements. However, it is noted that they could optionally be used.

Attention is now directed to sealant fields 129, 130, 133 and 134. In the preferred embodiment shown, these are used to ensure that panels 115 and 116 are sealed against panel 20, FIG. 4, so that the popcorn charge 30 is substantially retained in tube 29 (FIG. 4), and does not expand or spread substantially into tube 28 until desired during heating. In particular, fields 129 and 130 are oriented to engage one another, when the arrangement is folded about fold line 70 (with application of heat and pressure), and, fields 133 and 134 are oriented to engage one another, when the arrangement is folded about fold line 71 (with application of heat and pressure).

Seals of the type associated with fields 129, 130, 133, 134 have been used in previous constructions. For example, see U.S. Pat. No. 5,044,777.

In general, sealing results from application of heat and pressure, after folding, to the region where the sealant is located. It is noted that for the various seals discussed, sealant is positioned on both adjoining paper surfaces. This is convenient. However if sealant is only positioned on one side, and the two sides are folded together with follow-up application of appropriate heat and pressure, a seal can be formed.

It is noted that the sealant fields discussed are configured to form seals with application of heat and pressure. Alternate types of seals, for example cold seals, could be implemented in arrangements according to the present disclosure.

In the remaining discussion of sealant fields on surface 65 of package arrangement 60, FIG. 3, options are provided for preferred management and control of wicking and flow characteristics of the oil/fat in the popcorn charge, during storage, handling and use. It is noted that the sealant fields are used in one of two ways, as follows. First, a sealant field can actually be used to form an insulating seal, to manage location of the oil/fat, by insulating it from portions of the package. Secondly, application of a sealant to a paper surface changes the surface tension properties of that surface, and thus its interaction with the oil/fat material. In general the properties of the sealants used will operate for some containment of the oil/fat material into untreated locations. Thus, sealant fields can be applied to the paper at preferred locations where it is desired to inhibit flow of the oil/fat material as its liquefies. Both of these properties are discussed below, as well as options for implementing them.

There can, for example, be provided a seal arrangement that helps keep the popcorn charge, prior to popping, separated from undesirable levels of direct contact with creases at fold lines 66, 67, FIG. 3; i.e., folds 34, 39, FIG. 4. This technique is described in U.S. Provisional 60/544,873, filed Feb. 13, 2004, incorporated herein by reference.

With respect to fold line 66, attention is directed to sealant fields 150, 151; and, with respect to fold line 67, attention is directed to sealant fields 153, 154. It is noted that for the optional arrangement shown, fields 150, 151 are integral with one another, and meet at fold line 60, and that similarly fields 153, 154 are integral with one another and meet at fold line 67, although this is not required. (Alternately stated, fields 150, 151 are parts of a single field with fold line 60 therethrough, and preferably fields 153, 154 are parts of a single field with fold line 67 therethrough.)

When the fold around fold line 66 is made, sealant field 151 will overlap sealant field 150, with gusset fold insulating seal 155, FIG. 4, resulting by provision of appropriate heat and pressure. Similarly, when folding around fold line 67 occurs, field 154 will overlap field 153, with gusset fold insulating seal 156, FIG. 4, resealing when appropriate heat and pressure are applied.

When the popcorn charge is positioned in region 63, the popcorn charge, and components such as oil/fat therein, would be inhibited from flow to, creases or folds 66, 67 (i.e., creases at 34, 39, FIG. 4), due to the presence of the seals 155, 156. The seals 155, 156 would typically be configured to release, upon exposure to steam and heat during a microwave popcorn popping operation.

Herein, seals of the type of seals 155, 156, are sometimes be referred to herein as “insulating seals” with respect to an associated (typically adjacent) crease or fold. This is because these seals insulate the crease or fold, during package 1 storage, with respect to flow of material from within the popcorn charge, to direct contact with the associated crease or fold. Thus seal 155 is an insulating sealant field with respect to fold or crease along line 66 to form crease or fold 34 (FIG. 4); and field 156 is an insulating sealant field with respect to fold or crease line 67; i.e., fold or crease 39 (FIG. 4).

Referring to FIG. 3, it is noted that if used, preferably fields 150, 151, 153 and 154 are continuous, i.e. without gaps therein, in extension along the folds 66, 67. This continuous nature to the sealant fields, and in the resulting seals 155, 156 (FIG. 4) would help inhibit undesirable wicking or leaking at the creases caused in folds 66, 69. It is noted that some beneficial results would be obtained even if the insulating fields were not continuous.

When used, a preferred total length to the fields 150, 151 and 153, 154 is preferably at least 20% (usually at least 25% and typically at least 30%) of the entire length of the package (or length of the folds 66, 69) between ends 190, 193 (FIG. 2). More preferably there are each at least 45% of the length of the package 1, FIG. 2 or folds 66, 69, FIG. 3; most preferably and typically the length of the fields 150, 151, 153, 154 in the longitudinal direction of extension of the package, is 50%-60% of the total length of package 1, or folds 66, 69, (FIG. 3), between ends 90, 93. While alternatives are possible, these will be preferred seals. In FIG. 3, the portions of blank 60 that form ends 90, 93, FIG. 2, are edges 92a and 89a, respectively.

When used, most preferably the seals 155, 156 are at least positioned and configured to extend continuously between the folds of the tri-fold (corresponding folds 11, 12 respectively, FIG. 2).

Most preferably, when used, the fields 150, 151, 153, 154, FIG. 3, terminate with ends spaced from associated edges 92a, 89a of the package blank 60, which will correspond to ends 90, 93 of the folded package 1, FIG. 2. Preferably, the spacing is at least 70 mm (for example about 80-95 mm) from edge 89a; and, at least 70 mm from edge 92a. The spacing will not necessarily be the same, from each edge 89a, 92a. Indeed, in the embodiment shown it is not.

It is noted that a transverse seal between location 160, 161, for example similar to described in the U.S. provisional application 60/544,873 could also be used.

In some arrangements it may be desirable not to use continuous seals provided by fields 150, 151 and 153, 154. In some applications it may be desirable simply to provide seals formed by region 163, 164; 165, 166; 167, 168; and, 169, 170, when folding along lines 66, 67 as conducted. Specifically fields 163, 164 are shown as a circular dot of adhesive over line 66; and fields 165, 166 similarly form a circular field of adhesive over line 66, although non-circular shapes can be used. When folding along line 66 occurs, these fields will form spots of sealed adhesive adjacent the resulting gusset fold 34, FIG. 4, at these locations. This can help contain the oil/fat material, without using continuous seals.

An analogous affect is achieved along fold line 67, through seals formed from fields 167, 168, and 169, 170, when optional fields 153, 154 are not used. Again, circular or non-circular shapes can be used.

In some embodiments it may be desirable to provide adhesive over region 63, in the areas indicated at 175, 176, leaving central area 177 adhesive free. In general, oil/fat does not flow over a sealant field as well as it does over an untreated paper surface, especially if the paper surface is not fluorocarbon treated. Thus, sealant fields 175, 176 can help contain oil/fat material positioned in region 177. Similarly sealant treatment in regions 181 can be used for this purpose. That is, it would not actually form seals, but rather comprise surface treatments to inhibit undesirable flow of oil/fat material from region 177. The above features are optional, and can be used for different effects depending on the materials involved.

With respect to adhesive between plies, in some instances it will be desirable to provide continuous adhesive at certain locations, and discontinuous adhesive at others. In FIG. 3, the fields indicated at 200, with the dotted print pattern, are indicating a preferred location for having continuous coverage, depending, in part, on the nature of the paper used for the plies 46, 47. This is because the sealant can preferably be chosen to provide some beneficial greaseproof effect. In the regions 201 that are not dotted, it is expected that a discontinuous adhesive coverage such as, for example, described in: 5,753,895; 5,928,554 and 6,396,036, each of which is incorporated herein by reference, can be used.

Referring to FIG. 4, if used, preferably seals 155, 156 are at least 0.25 cm wide, typically and preferably at least 0.5 cm wide, typically about 0.8-1.4 cm. wide. In this context the “width” is the distance of extension inwardly, i.e., toward each other, from edges 155a, 156a, respectively. The seals 155, 156, of course, do not need to be of constant width, although they are shown this way.

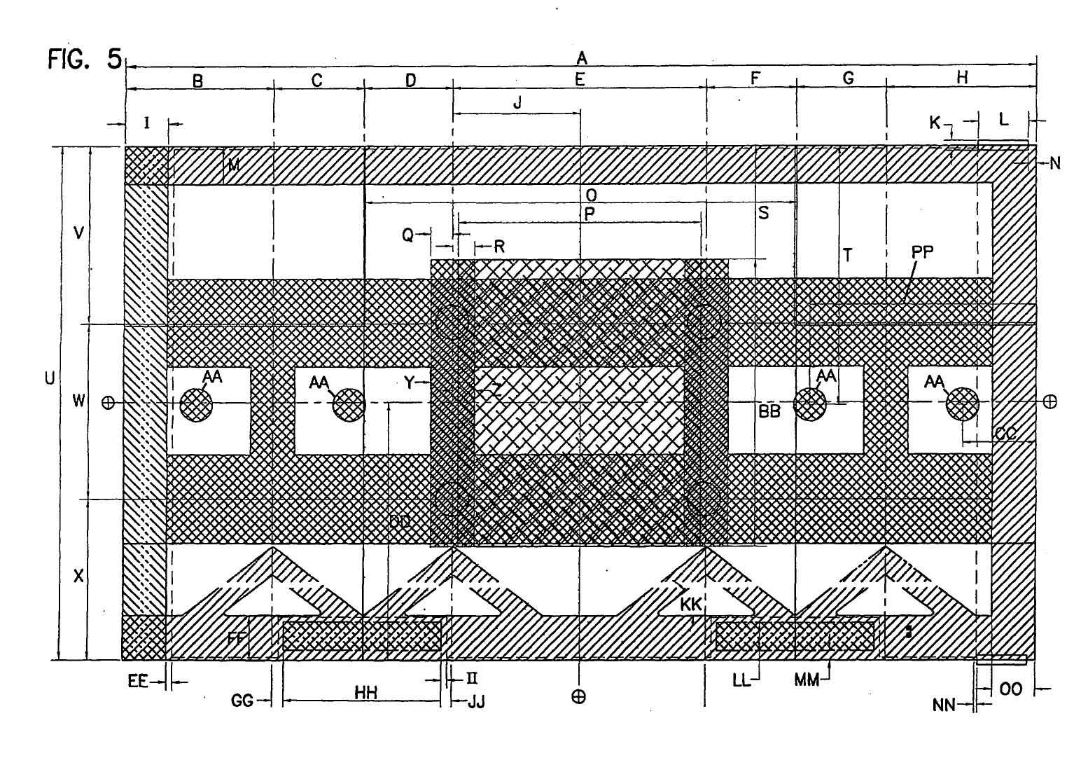

Attention is now directed to FIG. 5. FIG. 5 is a view analogous to FIG. 3, except with letter designations of certain dimensions. The dimensions provided herein, are for an example, as follows: (A) 21 inches (53.3 cm); (B) 3.4375 inches (8.7 cm); (C) 2.0625 inches (5.2 cm); (D) 2.0625 inches (5.2 cm); (E) 5.8750 inches (14.9 cm); (F) 2.0625 inches (5.2 cm); (G) 2.0625 inches (5.2 cm); (H) 3.4375 inches (8.7 cm); (I) 1 inch (2.5 cm); (J) 2.9375 inches (7.5 cm); (K) 0.2000 inches (0.5 cm); (L) 1.1562 inches (2.9 cm); (M) 0.8579 inches (2.2 cm); (N) 0.1875 inches (0.5 cm); (0) 10.0000 inches (25.4 cm); (P) 5.6250 inches (14.3 cm); (Q) 0.5 inches (1.3 cm); (R) 0.5 inches (1.3 cm); (S) 2.5625 inches (6.5 cm); (T) 5.8750 inches (14.9 cm); (U) 11.6250 inches (29.5 cm); (V) 4.0000 inches (10.2 cm); (W) 4.0000 inches (10.2 cm); (X) 3.6250 inches (9.2 cm); (Y) 0.5 inch (1.3 cm); (Z) 0.5 inch (1.3 cm); (AA) 0.750 inch (1.9 cm) diameter; (BB) 6.5 inch (16.5 cm); (CC) 1.6875 inch (4.3 cm); (DD) 5.8125 inch (14.8 cm); (EE) 0.1250 inch (0.3 cm); (FF) 1.0 inch (2.5 cm); (GG) 0.250 inch (0.6 cm); (HH) 3.6250 inch (9.2 cm); (II) 0.1250 inch (0.3 cm); (JJ) 0.2500 inch (0.6 cm); (KK) 37°; (LL) 0.6250 inch (1.6 cm); (MM) 0.2188 inch (0.6 cm); (NN) 0.06250 inch (0.2 cm); (OO) 1 inch (2.5 cm); (PP) 5.1875 inch (13.2 cm). Other dimensions can be determined assuming scale.

Fluorocarbon treated, or non-fluorocarbon treated, paper can be used for the plies of the package. If non-fluorocarbon treated paper as characterized in the next section as used, the following adhesives are example of useable materials. First, for the adhesive on surface the adhesive applied to surface 65, PWF 3007, available from H.B. Fuller Company, St. Paul, Minn. can be used. For the adhesive in regions 201 and 200 between plies, as a laminating adhesive, the product PWF 8540, also available from H. B. Fuller, can be used. PWF 3007 is a polyvinyl acetate. PWF 8540 is an ethylene vinyl acetate-polyvinyl alcohol (EVA-PVOH) adhesive, and can improve grease proofness. If fluorocarbon treated paper is used, PWF 3007 could be used both as the surface adhesive and as the laminating adhesive, if desired.

Useable arrangements and variations in packaging related to that shown in FIG. 3 are described in: (a) U.S. Provisional application 60/544,873, filed Feb. 13, 2004; (b) U.S. Provisional application 60/588,713, filed Jul. 15, 2004; (c) U.S. Provisional application 60/647,637, filed Jan. 26, 2005; (d) PCT US 05/04249 filed Feb. 11, 2005; and (e) U.S. Provisional application 60/574,703, filed May 25, 2004, filed as PCT US 05/08257 filed Mar. 11, 2005, these six references being incorporated herein by reference.

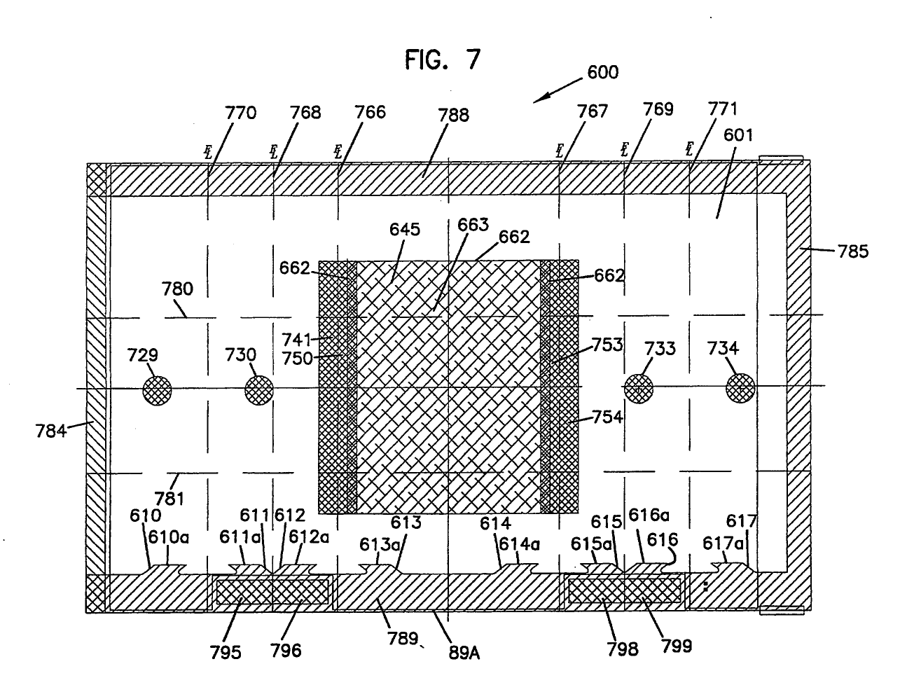

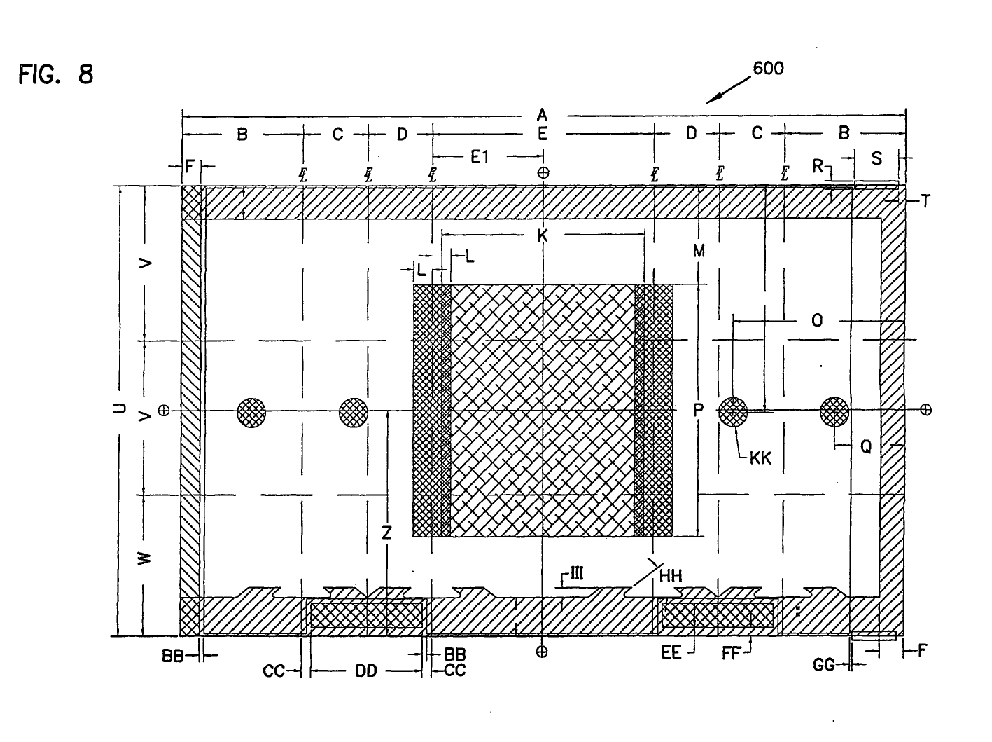

C. The Arrangement of FIGS. 7 and 8.

Reference numeral 600, FIG. 7, shows side 601 of an alternate package blank useable to form a packaged microwaveable popcorn product according to the present disclosure. The package blank of FIG. 7 is described in detail in PCT 05/04249 filed Feb. 11, 2005. Package blank 600 has region 663 for receipt of susceptor 645, with region 663 defined by border 662 and fields 750, 751 around fold line 766 and fields 753, 754 around fold line 767.

Additionally, blank 600 includes diagonal sealant fields 610, 611, 612, 613, 614, 615, 616 and 617 having innermost edges 610a, 611a, 612a, 613a, 614a, 615a, 616a and 617a, respectively, extending parallel to side edge 89a. Although analogous to similar regions in blank 60, FIG. 3, regions 610-617 have different dimensions.

Blank 600 can be used to form package 1, FIG. 1 as follows. The gusset folds will be formed by folds 766, 768 and 770 at one side, and folds 767, 769 and 771 at an opposite side. Package seams will be formed by fields 784, 785, 788 and 789. Tack seals would be formed by fields 795, 796, 798, 799, on an opposite side, from side 601. Tack seals would also be formed by fields 729, 730 and 733, 734. These latter tack seals, on side 601, would help keep the gusset closed. Containment seals for the central region 763, to contain oil movement into the gusset folds, will be formed by fields 751, 750 and by fields 753, 754. Overall folding into a tri-fold would be along lines 780, 781.

Attention is now directed to FIG. 8 which shows bag blank 600 with letters indicating example dimensions. The letters indicate example dimensions as follows:

A=19.125 inches (48.6 cm); B=3.1875 inches (8.1 cm); C=1.7188 inches (4.4 cm); D=1.1788 inches (4.4 cm); E=5.8750 inches (14.9 cm); E1=2.9375 inches (7.46 cm); F=0.5 inch (1.27 cm); K=5.3750 inches (13.65 cm); L=0.5 inch (1.27 cm); M=2.5625 inch (6.51 cm); O=4.5313 inch (11.5 cm); P=6.5 inch (16.5 cm); Q=1.8438 inch (4.68 cm); R=0.2 inch (0.51 cm); S=1.1562 inch (2.94 cm); T=0.1875 inch (0.48 cm); U=11.625 inch (29.5 cm); V=4 inches (10.2 cm); W=3.625 inches (9.21 cm); Z=5.8125 inches (14.8 cm); BB=0.125 inches (0.32 cm); CC=0.250 inches (0.64 cm); DD=2.9375 inches (7.46 cm); EE=0.6250 inches (1.59 cm); FF=0.2188 inches (0.56 cm); GG=0.0625 inches (0.159 cm); HH=37°; KK=0.75 inch diameter (19.05 mm); III=0.25 inch (6.35 mm).

It is noted that these dimensions are for a package blank with a slightly smaller outer perimeter than described for FIGS. 3 and 4 above. Of course similar features for the blank of FIG. 7 could be implemented in the size described above for the example of FIG. 4.

D. An Example Lamination Pattern.

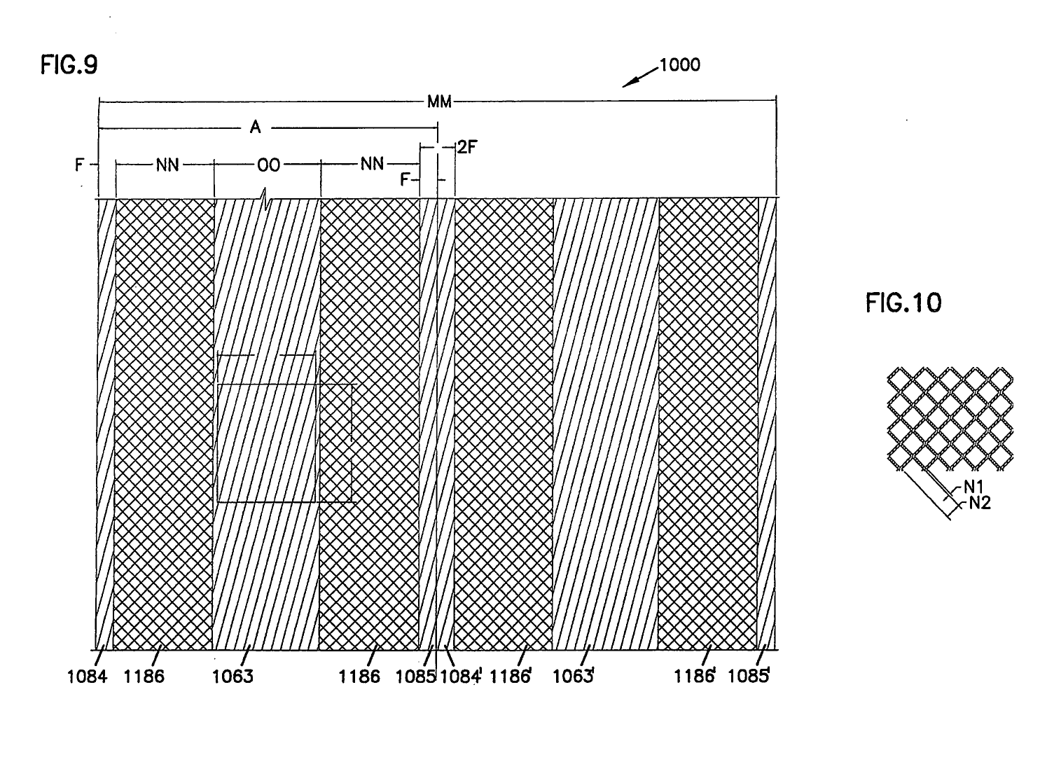

Referring to FIGS. 9 and 10, an example of a lamination pattern, for application between plies of blank 600 is depicted. The lamination adhesive is usually applied to one ply after which the two plies are joined together.

In FIG. 9, roll stock material 1000 is illustrated; roll stock 1000 is sufficiently wide to provide two package blanks, similar to blank 600 of FIG. 7.

Sealant regions 1063, 1063′, 1084, 1084′, 1085, 1085′ are regions of continuous adhesive. That is, there is a generally continuous and contiguous layer of adhesive thereon. Sealant regions 1186, 1186′ are regions having patterned, non-continuous adhesive. A useful non-continuous, yet contiguous, pattern for regions 1186, 1186′ is illustrated in FIG. 10.

Various dimensions are provided on FIGS. 9 and 10: (MM) 38.25 inch (97.15 cm); (A) 19.125 inch (48.58 cm); (F) 1.0 inch (2.54 cm); (2F) 2.0 inches (5.08 cm); (NN) 5.56 inches (14.13 cm); (OO) 6 inches (15.24 cm); (N1) 0.0625 inch (1.59 mm); (N2) 0.43 inch (10.9 mm). The bag blank resulting from the roll stock FIG. 9 would have similar outer dimensions to blank 600, but a roll stock having different dimensions could be made using the same principles, for example to prepare the package blank of FIGS. 3 and 4.

The roll stock of FIGS. 9 and 10 is described in detail, in PCT application US 05/04249, filed Feb. 11, 2005, incorporated herein by reference.

### V. Use of Non-Fluorocarbon Treated Paper

As discussed above, in some instances non-fluorocarbon treated paper can be used for the inner ply and/or the outer play.

A. Issues with Fluorocarbon Treated Papers.

Although to date there have not been specific government regulations regarding the matter, there is some perception that fluorocarbon treated paper materials may be undesirable, for use in microwave popcorn packaging. The issues generally relate to the work place environment of the package preparation and/or popcorn packaging facilities. There is, however, also at least some concern relating to possible fluorocarbon release during the microwave popcorn popping operation.

Generally, the fluorocarbon treatment in at least one of the plies of paper, has been considered to be very important with respect to obtaining desirable oil/fat retention characteristics, during storage, shipping and handling of the microwave popcorn products. Indeed many commercial paper microwave popcorn products, utilize fluorocarbon treated paper, to obtain desirable, reduced, wicking characteristics with respect to contained oil/fat within the unpopped popcorn charge contained therein.

Herein, there are reported preferred materials and constructions for microwave popcorn products, which provide for desirable levels of operation in a variety of microwave popcorn charges therein, with respect to wicking characteristics of contained oil/fat, without the use of fluorocarbon treated papers.

The information disclosed herein relating to non-fluorocarbon treated paper use is also described in: (a) U.S. Provisional application 60/552,560, filed Mar. 12, 2004; and (b) a U.S. Provisional application 60/574,703, filed May 25, 2004, these two references being incorporated herein by reference.

### B. Preferred Non-Fluorocarbon Treated Materials for Use in Preparing Multi-Ply Microwave Popcorn Packaging—Highly Refined Papers.

In general, the proper selection of raw fibers, as well as highly' refining the raw fibers in the process of manufacturing paper, result in the fibers themselves providing the resulting paper with the resistance to grease staining and paper grease proof properties. This grease resistance or grease proofness is the result of tight packing of the highly refined fibers of the sheet, physically preventing the migration of grease into and through the sheet. Highly refined fibers also absorb a high amount of water on the surface. This generates about a layer of water, providing for an hydrophilic characteristic to the paper surface, making the fibers and thus the paper intrinsically oil repellent.

In addition, highly refined fibers are more flexible. This can be important to microwave popcorn packaging, since with such packaging microfractures that occur during creasing and folding facilitate making the oil leakage. More flexible fibers will be less likely to be undesirably damaged, during folding or creasing processes.

To facilitate grease proofness and highly refined papers, film former is typically applied to the surface of the paper sheet. Examples of such film formers are copolymers of EVA (ethylene vinyl acetate) and PVOH (poly vinyl alcohol) or acrylics. An example is Johnson Polymer F41.

The general characteristics of preferred non-fluorocarbon (non-FCT) treated, highly refined, grease proof papers for use in microwave popcorn packaging are provided herein below. Some commercially available types of paper which meet these general characteristics are obtainable from Rhinelander Paper Company, Inc., Rhinelander, Wis., 54501. Rhinelander is a Wausau-Mosinee Company. The products are those designated by product code number 238-9577 and product code 238-9696. As will be apparent from the following, product number 238-9577 is particularly well configured for use as the inner sheet of a microwave popcorn bag, and product number 238-9696 is particularly useful as the outer ply of a microwave popcorn bag construction. Wausau 238-9696 is preferred for the outer sheet typically due to its higher opacity or greater whiteness. (Wausau 238-9646 is also useable for the outer sheet. It is similar to 238-9696, except with a higher basis wt.)

The term “highly refined” as used herein, sometimes abbreviated HR, is meant to have its ordinary definition from the paper making industry, in which in general oil and grease resistance is obtained in paper by reduction of porosity typically by refining an easily hydrated pulp to extremely low freeness, resulting in a closed sheet with a minimum or reduced space. Historically, valley beaters were used to accomplish this level of refinement. Modern paper mills generally use refiners to accomplish this.

In general it is preferred that the flexible paper material utilized for the inner sheet, i.e., the sheet which defines the interior surface of the bag construction, have a porosity (Gurley-sec) of no more than 300,000, preferably no more than 600,000 and most preferably 950,000 or less. Wausau grade 238-9577 meets this qualification, as a non-fluorocarbon treated material, but Wausau grade 238-9696 does not. (It is noted that higher Gurley-sec values are generally lower porosity. Thus the statement “or less” refers to higher numbers. The definition above could alternately have been a porosity value in Gurley-sec “of at least 300,000, more preferably at least 600,000, and most preferably 950,000.”

In general, for the outer ply, i.e., the layer which form the outer surface of a flexible microwave popcorn bag, it is preferred that highly refined (HR) paper material have a porosity (Gurley-sec) of no more than 30,000, preferably no more than 35,000 and typically and most preferably 40,000 or less. Both Wausau grade 238-9696 and Wausau grade 238-9577 meet this characteristic. (Also, Wausau grade 238-9696, 25# (25 lb) paper is useable for this.)

Preferably for each paper (ply), a material having basis wt. of 20-30 lb/ream is used. More preferably the basis wt. is not greater than 25 lbs/ream. Typically each sheet has a thickness (caliper) of 1.75-2.0 mils, typically no more than 1.9 mils, for example 1.8-1.9 mils.

1. Further Regarding Preferred Outer Ply Materials for Microwave Packaging.

In the following table (Table 1), comparative characteristics of two materials, usable as outer plies in preferred microwave popcorn packaging, are provided. The material designated “X” is a material commercially used for the outer ply in at least the following commercial products: Act II Butter (in 2003); Orville Reddenbacher Movie Theater Butter (in 2003); Act II Extreme Butter (in 2003). These products were manufactured and sold by ConAgra Foods, Inc., the assignee of the present invention.

The comparative is with the non-fluorocarbon treated, highly refined paper, Wausau Grade 238-9696 mentioned above. In Table 1, the caliper dimension is in mils (thousandths of an inch).

TABLE 1

| | | Wausau Grade 238- | |
|---|---|---|---|
| | | 9696 | |
| | X | Non-FCT Outer | Test Method |
| Fluorochemically Treated | Yes | No | |
| Basis Weight | 20.4 lbs/3000 sq. ft. | 21 lbs/3000 sq. ft. | TAPPI T 410 om-98 |
| Caliper | 1.74 mils | 1.81 mils | TAPPI T 411 om-97 |
| Porosity | 136 Gurley-sec | 42,000 Gurley-sec | TAPPI T 536 om-96** |
| Seffield Smoothness | 71 Sheffield | 135 Sheffield | TAPPI T 538 om-96 |
| Tear MD | 18 grams force | 18 grams force | TAPPI T 414 om-98 |
| Tear CD | 10.2 grams force | 11.5 grams force | |
| Opacity | 52% | 58% | TAPPI T 425 |
| 3M Kit Wire | 9 | NA | TAPPI 559 pm-96 |
| 3M Kit Felt | 9 | NA | |
| Color L | 94.6 | 93.2 | Datacolor instrument |
| Color a | −0.08 | −0.02 | (CIELAB/D50) |
| Color b | 3.8 | 1.6 | |
| Brightness | 84.8% | 85% | TAPPI T 452 om-98 |
| Turpentine | 2 minutes | 10 seconds | TAPPI T 454 om-94 |
| RP-2 Crease* | 100% | 14% | RP-2 (Ralston Purina) |

*% grid stained after 140 F for 24 hours (grid 10 cm × 10 cm)
**Seconds/100 cc of oil

2. Further Regarding Preferred Materials for Use as the Inner Ply, in Microwave Popcorn Packaging.

In the following Table 2, a comparative presentation is made of a fluorocarbon treated paper and a non-fluorocarbon treated paper, each of which is acceptable for use in preferred microwave popcorn packaging. The paper designated “Y” is a fluorocarbon treated paper commercially used as the inner ply of the microwave popcorn packaging of at least the above mentioned ConAgra commercial products. The product designated Wausau Grade 238-9577, is a highly refined, non-fluorocarbon treated paper.

TABLE 2

| | | Wausau Grade 238- | |
|---|---|---|---|
| | Y | 9577 Non-FCT Inner | Test Method |
| Fluorochemically Treated | Yes | No | |
| Basis Weight | 22.5 lbs/3000 sq. ft. | 23 lbs/3000 sq. ft. | TAPPI T 410 om-98 |
| Caliper | 2.0 | 1.85 | TAPPI T 411 om-97 |
| Porosity | 8000 Gurley-sec | 999,999+ Gurley-sec | TAPPI T 536 om-96** |
| Seffield Smoothness | 150 Sheffield | 151 Sheffield | TAPPI T 538 om-96 |
| Tear MD | 17 grams force | 16 grams force | TAPPI T 414 om-98 |
| Tear CD | 18 grams force | 8 grams force | |
| Opacity | 42% | 38% | TAPPI T 425 |
| 3M Kit Wire | 10 | NA | TAPPI 559 pm-96 |
| 3M Kit Felt | 12 | NA | |
| Color L | 94.0 | 92.6 | Datacolor instrument |
| Color a | −2.0 | −1.5 | (CIELAB/D50) |
| Color b | 6.0 | 5 | |
| Brightness | 81% | 80% | TAPPI T 452 om-98 |
| Turpentine | 180 minutes + | 3 minutes | TAPPI T 454 om-94 |
| RP-2 Crease* | 0.20% | 1.90% | RP-2 (Ralston |
| | | | Purina) |

*% grid stained after 140 F for 24 hours (grid 10 cm × 10 cm)
**seconds/100 cc of oil

What is claimed is:

1. A packaged microwaveable popcorn product comprising:
(a) a closed microwave popcorn package;
(b) unpopped popcorn kernels positioned within the package; and,
(c) an oil/fat slurry positioned within the package; the oil/fat slurry including oil/fat material having a Mettler drop point of at least 100° F.; the oil/fat material including a first oil/fat component comprising at least 90% of oil/fat blend selected from the following blends and mixtures thereof:
(i) interesterified blend of:
(A) 5 to 50%, by wt., of the mixture that undergoes interesterification, of a first stearine component; and,
(B) 50-95%, by wt., of the mixture that undergoes interesterification of oil component having a saturated fat content of no greater than 50% and a Mettler drop point of no greater than 100° F.;
(ii) physical oil blend comprising a melt blend of:
(A) at least 80%, by wt., of liquid oil component having at least one of: a Mettler drop point of no greater than 90° F.; and, a solid fat content at 70° F. of no greater than 30%; the liquid oil component including no more than 49% by wt. palm oil, if any; and,
(B) at least 5%, by wt., of a solid fat component having a Mettler drop point of at least 130° F.; and,
(iii) palm oil blend:
(A) having a saturated fat content of no greater than 60% and a Mettler drop point of no greater than 125° F.; and
(B) formed from a mixture of
(1) 40 to 90%, by wt., of a liquid palm oil component having a Mettler drop point of no greater than 106° F.; and;
(2) 10 to 60%, by wt., solid palm fat component having a Mettler drop point of at least 120° F.;
(d) the first oil/fat component being present in the packaged microwaveable popcorn product at a level of:
(i) at least 32%, by wt. of the oil/fat material; and,
(ii) at least 3%, by wt., of the unpopped popcorn kernels.

2. A packaged microwaveable popcorn product according to claim 1 wherein:
(a) the first oil/fat component comprises at least 80%, by wt., of the oil/fat material and is present at a level of at least 8%, by wt., of the unpopped popcorn kernels.

3. A packaged microwaveable popcorn product according to claim 2 wherein:
(a) the first oil/fat component comprises at least 99%, by wt., of the oil/fat material and is present at a level of at least 10%, by wt., of the unpopped popcorn kernels.

4. A packaged microwaveable popcorn product according to claim 3 wherein:
(a) the first oil/fat material has a Mettler drop point within the range of 110°-135° F.

5. A packaged microwaveable popcorn product according to claim 4 wherein:
(a) the first oil/fat component comprises at least 90%, by wt., of an interesterified blend according to claim 1(c)(i).

6. A packaged microwaveable popcorn product according to claim 5 wherein:
(a) the interesterified blend is an interesterified blend of:
(i) 10-40%, by wt., of the first stearine component having a Mettler drop point of at least 130° F. and not greater than 170° F.; and,
(ii) 60-90%, by wt., of oil component selected from the group consisting essentially of: soybean oil, canola oil, sunflower oil, corn oil, rapeseed oil, cottonseed oil, mid-oleic sunflower oil, safflower oil, partially hydrogenated one(s) of the identified oils having an iodine value(s) of at least 90; and, mixtures thereof.

7. A packaged microwaveable product according to claim 6 wherein:
(a) the first oil/fat component comprises at least 95%, by wt., of an interesterified blend of:
(i) 15-30%, by wt, of the first stearine component; and,
(ii) 70-85%, by wt., of the oil component.

8. A packaged microwaveable product according to claim 7 wherein:
(a) the first oil/fat component comprises a blend including:
(i) the interesterified blend; and,
(ii) at least 1%, by wt., of second stearine component having a Mettler drop point of at least 130° F. and not greater than 170° F.

9. A packaged microwaveable popcorn product according to claim 7 wherein:
(a) the first and second stearine components are each independently selected from the group consisting essentially of: cottonseed stearine; soybean stearine; and, mixtures thereof.

10. A packaged microwaveable product according to claim 7 wherein:
(a) the first stearine component comprises soybean stearine;
(b) the oil component used in the interesterified blend comprises soybean oil; and,
(c) the first oil/fat component comprises:
(i) at least 99%, by wt., of all oil/fat in the oil/fat slurry;
(ii) 10-60%, by wt., of the unpopped popcorn kernels; and,
(iii) a blend of:
(A) at least 2%, by wt., soybean stearine; and,
(B) at least 95%, by wt., interesterified blend.

11. A packaged microwaveable popcorn product according to claim 4 wherein:
(a) the first oil/fat component comprises at least 90%, by wt., of a physical oil blend according to 1(c)(ii) having a Mettler drop point of at least 115° F. and a saturated fat content of no greater than 50%.

12. A packaged microwaveable popcorn product according to claim 11 wherein:
(a) the physical oil blend is a blend including a liquid oil component selected from the group consisting essentially of: soybean oil; canola oil; sunflower oil; corn oil; rapeseed oil; cottonseed oil; safflower oil;
partially hydrogenated one(s) of the identified oils having iodine value(s) of at least 90; palm oil at a level of no more than 49%, by wt., of the liquid oil component; and, mixtures thereof.

13. A packaged microwaveable popcorn product according to claim 12 wherein:
(a) the physical oil blend is a blend including a solid fat component having a Mettler drop point of at least 130° F. and not greater than 170° F.

14. A packaged microwaveable popcorn product according to claim 12 wherein:
(a) the physical oil blend is a blend including a solid fat component selected from the group consisting essentially of: soybean stearine, cottonseed stearine, corn stearine, palm stearine, hydrogenated palm stearine, hydrogenated palm fruit oil and mixtures thereof.

15. A packaged microwaveable popcorn product according to claim 12 wherein:
(a) the physical oil blend includes at least 0.5%, by wt., emulsifier selected from the group consisting essentially of mono-glycerides, di-glycerides, mixtures of mono and di-glycerides, polyglycerol esters of fatty acids, partially hydrogenated monoglycerides, fully hydrogenated monoglycerides, propylene glycol esters of fatty acids and mixtures thereof.

16. A packaged microwaveable popcorn product according to claim 11 wherein:
(a) the liquid oil component has a Mettler drop point of no greater than 70° F. and a solid fat content of no greater than 30% at 70° F.

17. A packaged microwaveable popcorn product according to claim 11 wherein:
(a) the first oil/fat component comprises at least 90%, by wt., of a melt blend of:
(i) 82-88%, by wt., liquid oil component selected from corn oil, cottonseed oil and mixtures thereof;
(ii) 7-13%, by wt., soybean stearine; and,
(iii) 2-7%, by wt., mono-glyceride material.

18. A packaged microwaveable popcorn product according to claim 4 wherein:
(a) the first oil/fat component comprises at least 90%, by wt., of a palm oil blend according to 1(c)(iii).

19. A packaged microwaveable popcorn product according to claim 18 wherein:
(a) the palm oil blend is a blend of:
(i) 40-90%, by wt., first liquid palm oil component selected from the group consisting essentially of: palm fruit oil, palm olein or mixtures thereof; and
(ii) 10-60%, by wt., solid palm oil/fat component selected from the group consisting essentially of palm stearine; fractionated palm stearine; hydrogenated palm oil and mixtures thereof.

20. A package of microwaveable popcorn product according to claim 19 wherein:
(a) the blend includes 75-80%, by wt., palm fruit oil; and,
(b) 15-25%, by wt., palm stearine.

21. A packaged microwaveable popcorn product according to claim 1 wherein:
(a) the closed microwave popcorn bag comprises a flexible bag having first and second face panels, with first and second opposite, inwardly directed, gusset folds therebetween;
(i) the flexible bag including a microwave interactive susceptor therein positioned as part of the first face panel.

22. A packaged microwaveable popcorn bag according to claim 21 including:
(a) a first gusset fold seal arrangement including a seal between an inside surface portion of the first face panel and an adjacent gusset panel member of the first inwardly directed gusset fold; and,
(b) a second gusset fold seal arrangement including a seal between an inside surface portion of the first face panel and an adjacent gusset panel member of the second inwardly directed gusset fold.
